(19) United States
(12) Patent Application Publication
(10) Pub. No.: US 2014/0025368 A1
(43) Pub. Date: Jan. 23, 2014

(54) Fixing Broken Tagged Words

(71) Applicants: Hongxia Jin, San Jose, CA (US); Qihua Wang, San Jose, CA (US)

(72) Inventors: Hongxia Jin, San Jose, CA (US); Qihua Wang, San Jose, CA (US)

(73) Assignee: INTERNATIONAL BUSINESS MACHINES CORPORATION, Armonk, NY (US)

(21) Appl. No.: 13/551,808

(22) Filed: Jul. 18, 2012

(51) Int. Cl. G06F 17/27

(52) U.S. Cl. 704/9

(57) ABSTRACT

Embodiments of the invention relate to a method, system, and computer program product to identify broken tag words of a data item and to replace the broken tag words with a compound word. Data items that have at least two tag words are examined to determine if the tag words are broken elements of a compound word. A computational assessment is conducted to determine a relationship between a set of compound words and an examined data item. Based upon the computational assessment a set of broken tag words may be replaced with a related compound word.

### BACKGROUND

This invention relates to the recovery of compound words. More specifically, the invention relates to the replacement of tag words separately attached to a data item with a compound word.

Tagging is a process of attaching a relevant word, commonly referred to as a tag, to a data item for purposes of improved information retrieval and classification of the data item. While tagging is a prevalent method for data classification and retrieval, the quality of a user inputted tag is limited by a system's understanding of the user input. Specifically, a problem arises when a user inputs a compound word as two broken words since current systems often incorrectly recognize the two broken words as multiple inputs. These inputs are often reordered by a system, disconnecting the stems of the broken compound word and leading to misinterpretations from a system or a user.

While removing these broken tags would be desired, it is preferable to repair the broken tags by replacing them with the originally intended compound word, so as not to require additional input from a user. This invention therefore proposes a solution for recovering a compound word by replacing broken tag words with the correct compound word.

### BRIEF SUMMARY

This invention comprises a method, system, and computer program product for recovering a compound word by replacing at least two attached data item tag words with the compound word.

In one aspect, a method is provided to recover a compound word. A set of semantically related secondary words is identified for at least one compound word in a list of compound words. The compound words are words comprised of at least two stem words. Compound words from the list of words having each of its stem words contained in tag words attached to a data item are further identified. A semantic relationship between the identified compound words and the data item are computed. A compound word from the list of compound words is recovered by replacing at least two attached tag words with the recovered compound word, provided that the compound word is determined to be semantically related to the data item.

In another aspect, a system is provided with a shared pool of configurable resources having a physical host in communication with a plurality of physical machines. The physical host is provided with a processing unit in communication with a memory module and data storage. The data storage is provided to store a list of compound words, where each compound word in the list has at least two stem words. A functional unit is further provided local to the memory module and in communication with the processing unit. The functional unit has tools to support the identification and correction of a tag word attached to a data item. The tools provided in the functional unit include an identification manager, an examination manager, a computation manager, and a recovery manager. The identification manager is programmed to identify a set of one or more secondary words that are semantically related to a compound word in the list. The examination manager examines the data item by identifying compound words from the list that have each of the stem words of the compound word contained in the tag words attached to the data item. The computation manager, which is in communication with the examination manager, computes a semantic relationship between one of the identified compound words and the data item. The recovery manager recovers at least one identified compound word from the list determined to be semantically related to the data item by replacing at least two attached tag words with the recovered compound word. Recovering a compound word from the list of compound words in data storage allows for the identification of broken stem words and the recovery of a corresponding compound word.

In a further aspect, a computer program product for use with a data item and an attached tag word is provided. The computer program product comprises a computer readable non-transitory storage medium having computer readable program code embodied therewith. The computer readable program code when executed aims to recover a compound word by replacing two associated tag words attached to a data item with the compound word. The computer readable program code identifies a set of secondary words semantically related to at least one compound word in a list of compound words. Each compound word includes at least two stem words. The computer readable program code further examines data items that have at least two attached tag words. More specifically, the code to examine data items includes identification of compound words from the list and each of the stem words in the identified compound word(s) contained in the tag words attached to the data item. The computer readable program code computes a relationship between the identified compound words and the data item, and based on the computed relationship recovers a compound word determined to have a contextual relationship with the data item. The recovery of the compound word includes replacement of the attached tag words with the recovered compound word.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a flow chart illustrating a preparation phase to support identification of one or more broken tags.

FIG. 2 depicts a flow chart illustrating the recovery phase for correction of a broken tag.

FIG. 3 depicts a block diagram illustrating tools embedded in a computer system to support the identification of broken tag words and replacement with one or more compound words.

FIG. 4 depicts a cloud computing node according to an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit(s) described in this specification has been labeled with tools in the form of managers. A manager may be implemented in programmable hardware devices such as field programmable gate arrays, programmable array logic, programmable logic devices, or the like. The managers may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of an application manager, a replication manager, a migration manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A tag word is referred to herein as a word attached to a figure, picture, description, etc. The tag word may be descriptive or may serve as an identifier. The tag word may be attached by a single user or separately attached by multiple users. As such, a single item may include more than one tag word. Broken tag words, also known as broken tags, are referred to herein as tag words that are a part of a compound word but are separately attached to the single item.

A word stem is a base part of a word that has prefixes and suffixes and a compound word is a single word made up of two or more other words. The compound word may be considered to include at least two stems words. When a data item contains two or more tag words, the issue arises whether the tag words are stem words of a single compound word, and if so how the broken tag words can be assessed and replaced with a single compound word. A recovery process is employed to alleviate the problems associated with broken tag words. Specifically, broken tag words are known to occur, and these tag words must be fixed in order to resolve the problems with broken tag words. Independently the broken tag words may have a different contextual interpretation than the compound word. A proper correction returns the proper definition and interpretation to the associated data item. More specifically, the proper correction requires identification of the broken compound words from a set of tag words. This includes identifying broken compound words from tag words that may be naturally related. After the broken tag words are identified, a recovery phase is employed for correction thereof. Accordingly, there are two primary components to correction and replacement of broken tag words, including identification and recovery of broken tag words.

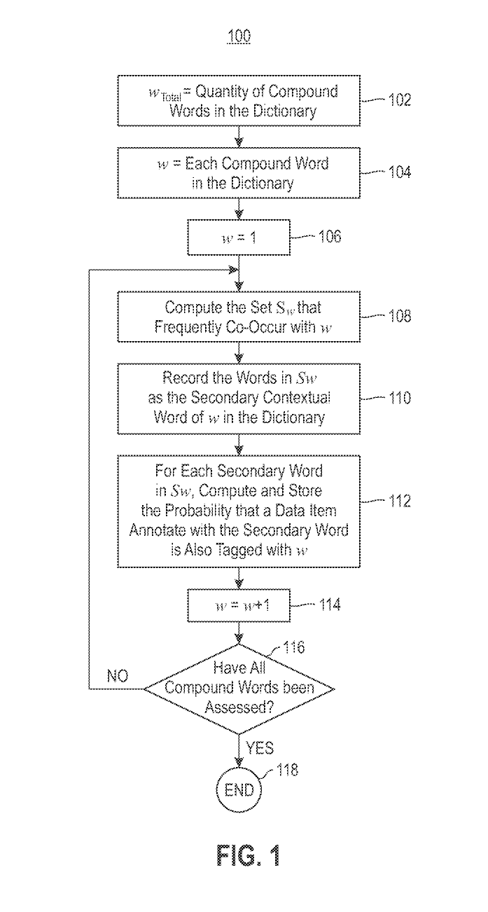

FIG. 1 is a flow chart (100) illustrating a preparation phase to support identification of one or more broken tag words. The preparation process creates a list of compound words, also referred to herein as a dictionary. The list may contain correctly applied compound words in existing tags, and it may include compound words from an existing word dictionary. In one embodiment, each compound word is comprised of at least two words separated by a hyphen. The variable w_{Total} represents the quantity of compound words in the dictionary (102), and the variable w represents each compound word in the dictionary (104). The variable w is set to the integer one (106), and the set of secondary contextual words, S_{w}, that frequently co-occur with the compound word w is computed (108). In one embodiment, the computation at step (108) pertains to the frequency at which a secondary contextual word and a compound word co-occur among a plurality of data items in the system. The set of secondary contextual words, S_{w}, is recorded as the context of w in the list (110). Accordingly, for each assessed compound word, a set of secondary words semantically related to and determined to frequently occur with the compound word is identified.

For each secondary word t in S_{w} associated with the compound word w, the P(w|t) is computed and stored in the dictionary, indicating the probability that a data item that is annotated with word, t, is also tagged with the compound word, w, (112). This probability can again be determined by the frequency of the words t and w co-occurring in all data items in the system. For example, the probability can be calculated as the ratio between the number of times the words t and w co-occur in data items and the number of times word w occurs (is tagged) in data items. Since there is a defined quantity of compound words in the dictionary, the next compound word in the dictionary is set (114), followed by a determination of whether each of the compound words in the dictionary has been assessed for secondary contextual words (116). A negative response to the determination at step (116) is followed by a return to step (108), and a positive response to the determination at step (116) concludes the compound word assessment for the dictionary (118). Accordingly, each word in the dictionary, w, is assessed to ascertain the set of tag words that frequently occur together with the probability assessment.

A tagging instance may be represented as a tuple <I, X, u, T>, where I is an item, X is the text of I, u is a user, and T is a set of tag words. The tagging instance indicates that u has applied tag words in T to I, when the instance is from a social bookmark, R is a resource and X is a snippet of I. When the instance is from a mutual tag, I is a person and X is empty. The recovery phase examines tagging instance on an individual basis.

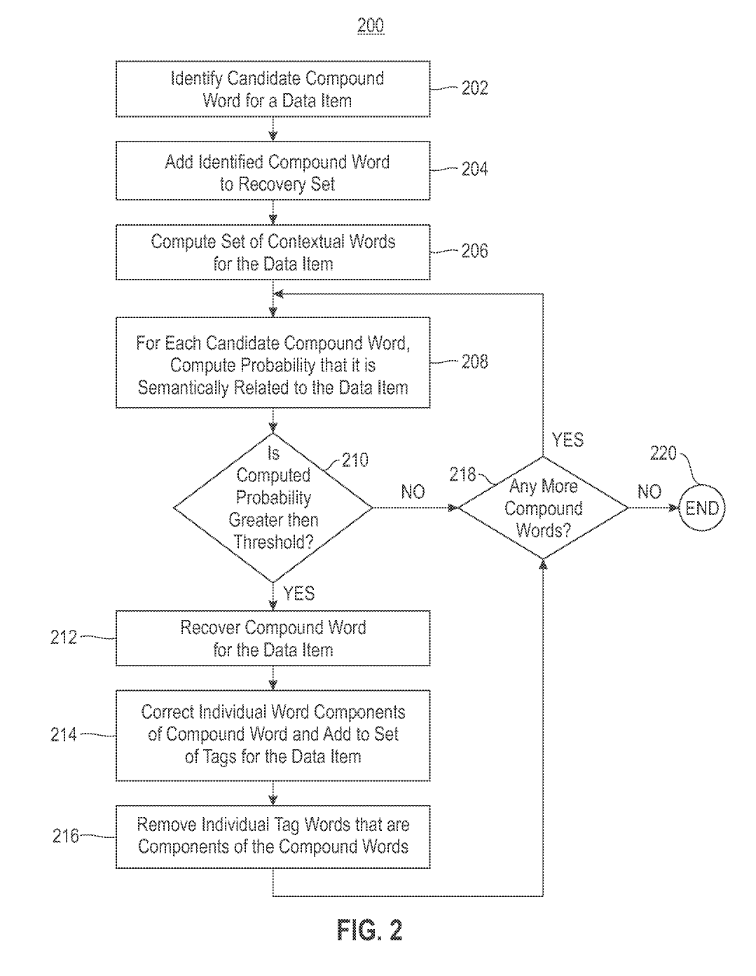

FIG. 2 is a flow chart (200) illustrating the recovery phase for correction of a broken tag. Given the tuple <I, X, u, T> as defined above, broken tags in T for data item I are recovered. First, one or more candidate compound words, are identified for the data item I (202). Specifically, if a compound word w is found in the dictionary such that all the components, e.g. stem words, of w appear as individual tag words in the set of tag words T, then the compound word, w, is called a candidate compound word for data item I and is added to a set of candidate compound words for recovery (204). Following step (204), context comparison is employed to determine if a-compound word, w, is semantically related to the data item I. In order to do this context comparison, first, a set of contextual words of the item I is computed (206). In one embodiment, the set of secondary contextual words for data item I contain all of the tags that have been applied to I by any user in the system. In one embodiment, when the textual content X of item I is not empty, the keywords in X may be added to the set of contextual words. For each candidate compound word w in the set of candidate compound words for recovery, the probability that I is or is not related to the compound word w is computed (208). In one embodiment, the following formula is employed for the computation at step (208):

P(NOT w|t₁, . . . , tₘ)=P(NOT w|t₁)(P(NOT w|t₂) . . . (P(NOT w|tₘ)

where t₁, . . . tₘ are the contextual words in the set of contextual words for data item I, P (NOT w|tᵢ)=1−P (w|tᵢ), and P (w|tᵢ) is the probability that an item that is annotated with tᵢ is also tagged with w. As shown in FIG. 1, the probability is computed and stored in the dictionary during the preparation phase. Accordingly, the probability as assessed at step (208) employs the probability computation in the preparation phase.

Following step (208), it is determined if the computed probability exceeds a set threshold value (210). If P(NOT w|t₁, . . . , tₘ) is smaller than a threshold or if P(w|t₁, . . . , tₘ) is greater than a threshold, it is concluded that the compound word, w, is determined to be semantically related to I. The compound word, w, is recovered for data item I (212). To recover or replace a compound word w, the individual word components of the compound word are connected and the result is added to the set of tags, T, for the item I (214). In one embodiment, a hyphen connects the individual word components of the compound word. In addition, the individual tag words that are components, e.g. stems, of the compound word w are removed from the set of tags T (216) If at step (210) it is determined that the compound word, w, is not semantically related to I, or following step (216), it is determined if there are more compound words to be assessed (218). A positive response to the determination at step (218) is followed by a return to step (208), a negative response concludes the identification and assessment of candidate compound words (220). Accordingly, as demonstrated, the recovery process removes the broken pieces, e.g. broken tag words, and replaces them with the recovered compound word.

As demonstrated in the identification and recovery processes, a probability value is assessed proportional to a frequency at which a secondary word and a compound word co-occur. Based on the assessment, a set of two or more broken words for a data item may be replaced by a single compound word from the list. In one embodiment, the two attached tag words are stems of a broken compound word. Similarly, as noted above, the list contains a plurality of compound words. In one embodiment, the compound words in the list comprise at least two stem words separated by a hyphen. Accordingly, the identification and recovery processes function together to address data items having tag words that may be replaced with identified broken stems of a compound word.

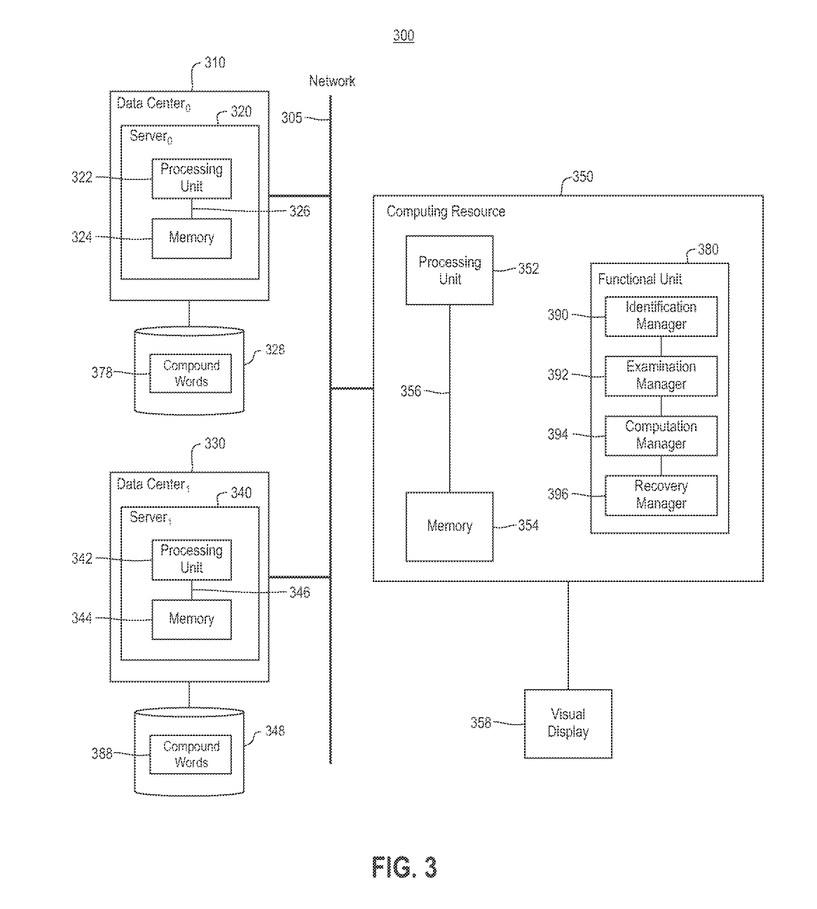

As shown in FIGS. 1 and 2 described above, a method is provided to support identification and replacement of multiple tag words in a data item with a compound word. In one embodiment, the multiple tag words are determined to be broken words of a compound word. Each compound word is comprised of at least two stem words. The relationship between the compound word and the stem words is identified, and then utilized as a support tool for identification and recovery of broken tag words. More specifically, broken tag words change the context of the data item to which they are attached. A stem word detached from a compound word provides a different definition and understanding of the data item to which it is attached. FIG. 3 is a block diagram (300) illustrating tools embedded in a computer system to support the identification of broken tag words and replacement with one or more compound words. A shared pool of configurable computer resources is shown with a first data center (310) and a second data center (330). Although two data centers are shown in the example herein, the invention should not be limited to this quantity of data centers in the computer system. Accordingly, one or more data centers may be employed in a shared pool of resources to support mitigation of broken words as tags for one or more data items.

Each of the data centers in the system is provided with at least one server in communication with data storage. More specifically, the first data center (310) is provided with a server (320) having a processing unit (322), in communication with memory (324) across a bus (326), and in communication with data storage (328); and the second data center (330) is provided with a server (340) having a processing unit (342), in communication with memory (344) across a bus (346), and in communication with second local storage (348). Server (320) may communicate with server (340) across a network connection (305).

A client site (350) is shown in communication with the first data center (310) and the second data center (330). The client site (350) includes a processing unit (352) in communication with memory (354) across a bus (356). The client site (350) is also provided with a visual display (358). In one embodiment, the client site (350) may be in the form of a personal computer, a laptop computer, a mobile communication device, etc. A functional unit (380) is provided local to the client site (350) or one of the data centers (310) and (330). For descriptive purposes, the functional unit (380) is described herein as local to the client site (350). The functional unit (380) is provided with one or more tools to support the aspect of managing application of or correction of tags applied to one or more data items. The tools include, but are not limited to, an identification manager (390), an examination manager (392), a computation manager (394), and a recovery manager (396). Together, the managers and their functionality support the identification and recovery of broken tags of a compound word.

As shown, there are at least two data storage components in the group of shared resources. The first data center (310) is provided with data storage member (328) and the second data center (330) is provided with data a second data storage member (348). A list of compound words (378) and (388) are stored in the data storage member (328) and (348), respectively. Each of the compound words in the list has at least two stem words. As described above, the functional unit (380) is shown herein local to the client site (350). The identification manager (390) is provided to identify one or more sets of secondary words. Each of the identified secondary words is related to at least one compound word. The examination manager (392), which is provided in communication with the identification manager (390), examines data items having at least two attached tag words. More specifically, the examination manager (392) identifies compound words in the list that include stems words of the identified compound words from one or more of the lists (378) and (388). In one embodiment, at least two of the tag words attached to the data item are stem words of a broken compound word. Similarly, in one embodiment, each compound word in the list of compound words comprises at least two stem words separated by a hyphen character. Accordingly, each of the stem words in the identified compound words is contained in the attached data item tag words.

The computation manager (394) is provided in communication with the examination manager (392). The identification and examination managers (390) and (392) identify secondary words and tag words, and ascertain an associated compound word. However, identification of the associated compound word extends beyond the functionality of the identification and examination managers (390) and (392). The computation manager (394) functions to provide a numerical assessment to the relationship between the compound word(s), secondary words, and tag words. More specifically, the computation manager (394) provides an assessment and numerical computation of a relationship between each identified compound word in the list and the data item to which the tag word(s) are attached. In one embodiment, the numerical computation may be in the form of a probability value proportional to a frequency of co-occurrence of a secondary word and a compound word. Similarly, in one embodiment, the computation of the relationship between a compound word and the data item to which the tags are attached is based on the secondary words being related to the compound word associated with the data item. Accordingly, the computation manager (394) provides a numerical assessment and valuation to the relationship between the compound word, data items, and attached tags.

The recovery manager (396) is provided to communicate with the computation manager (394), and more specifically, to recover a compound word from the list that has been numerically assessed by the computation manager (394) to be related to the data item to which the tag word(s) have been attached. The recovery manager (396) functions to correct any assessed errors associated with identified broken tags, and replaces two or more tags attached to a data item with a recovered compound word. Accordingly, the managers identified herein numerical assess the probabilities of a broken words attached to a data item and its relationship to a compound word stored in the list of compound words.

The identification manager (390), examination manager (392), computation manager (394), and recovery manager (396) are configured to address broken words attached to a data item and replacement of the broken words with an appropriate compound word. As identified above, the identification manager (390), examination manager (392), computation manager (394), and recovery manager (396) are shown residing in memory (354) of the client machine (350). In one embodiment, the managers (390)-(396) may reside in memory local to one or more of the data centers. Similarly, in one embodiment, the managers (390)-(396) may reside as hardware tools external to memory and may be implemented as a combination of hardware and software, or may reside local to memory of any one of the data centers or client sites in the shared pool of resources. Similarly, in one embodiment, the managers may be combined into a single functional item that incorporates the functionality of the separate items. As shown herein, each of the manager(s) are shown local to the client machine. However, in one embodiment they may be collectively or individually distributed across the shared pool of configurable computer resources and function as a unit to address and recover broken tags with a compound word to appropriately and accurately identify data items. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

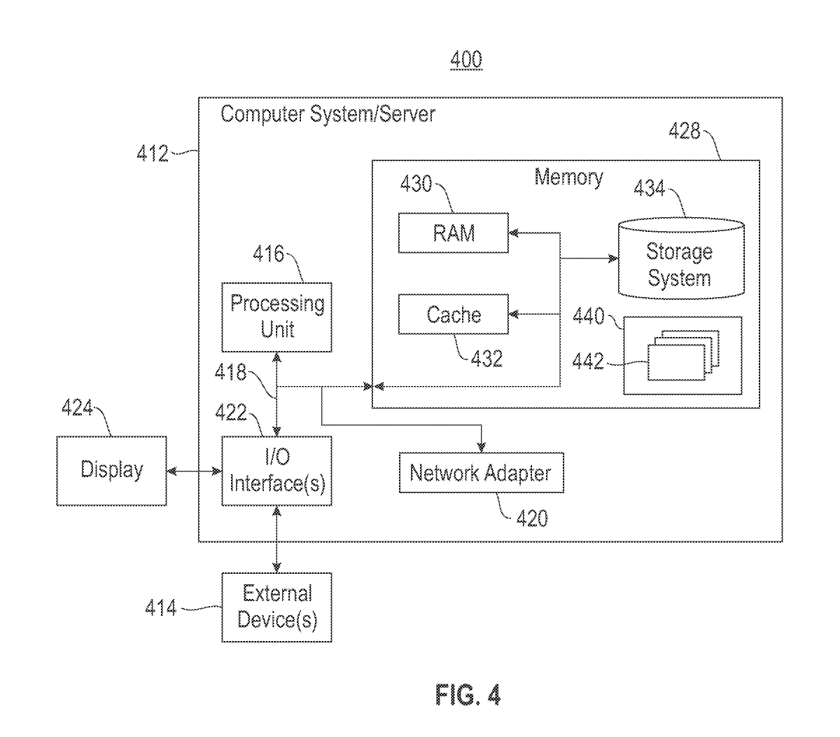

In one embodiment, the replacement of tag words separately attached to a data item with a compound word may take place in a pool of shared resources, e.g. cloud computing environment. The cloud computing environment is service oriented with a focus on statelessness, low coupling, modularity, and semantic interoperability. At the heart of cloud computing is an infrastructure comprising a network of interconnected nodes. Referring now to FIG. 4, a schematic (400) of an example of a cloud computing node is shown. Cloud computing node (400) is only one example of a suitable cloud computing node and is not intended to suggest any limitation as to the scope of use or functionality of embodiments of the invention described herein. Regardless, cloud computing node (400) is capable of being implemented and/or performing any of the functionality set forth hereinabove. In cloud computing node (400) there is a computer system/server (412), which is operational with numerous other general purpose or special purpose computing system environments or configurations. Examples of well-known computing systems, environments, and/or configurations that may be suitable for use with computer system/server (412) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (412) may be described in the general context of computer system-executable instructions, such as program modules, being executed by a computer system. Generally, program modules may include routines, programs, objects, components, logic, data structures, and so on that perform particular jobs or implement particular abstract data types. Computer system/server (412) may be practiced in distributed cloud computing environments where jobs are performed by remote processing devices that are linked through a communications network. In a distributed cloud computing environment, program modules may be located in both local and remote computer system storage media including memory storage devices.

As shown in FIG. 4, computer system/server (412) in cloud computing node (400) is shown in the form of a general-purpose computing device. The components of computer system/server (412) may include, but are not limited to, one or more processors or processing units (416), a system memory (428), and a bus (418) that couples various system components including system memory (428) to processor (416). Bus (418) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server (412) typically includes a variety of computer system readable media. Such media may be any available media that is accessible by computer system/server (412), and it includes both volatile and nonvolatile media, removable and non-removable media.

System memory (428) can include computer system readable media in the form of volatile memory, such as random access memory (RAM) (530) and/or cache memory (432). Computer system/server (412) may further include other removable/nonremovable, volatile/non-volatile computer system storage media. By way of example only, storage system (434) can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (418) by one or more data media interfaces. As will be further depicted and described below, memory (428) may include at least one program product having a set (e.g., at least one) of program modules that are configured to carry out the functions of embodiments of the invention.

Program/utility (440), having a set (at least one) of program modules (442), may be stored in memory (428) by way of example, and not limitation, as well as an operating system, one or more application programs, other program modules, and program data. Each of the operating systems, one or more application programs, other program modules, and program data or some combination thereof, may include an implementation of a networking environment. Program modules (442) generally carry out the functions and/or methodologies of embodiments of the invention as described herein.

Computer system/server (412) may also communicate with one or more external devices (414), such as a keyboard, a pointing device, a display (424), etc.; one or more devices that enable a user to interact with computer system/server (412); and/or any devices (e.g., network card, modem, etc.) that enable computer system/server (412) to communicate with one or more other computing devices. Such communication can occur via Input/Output (I/O) interfaces (422). Still yet, computer system/server (412) can communicate with one or more networks such as a local area network (LAN), a general wide area network (WAN), and/or a public network (e.g., the Internet) via network adapter (420). As depicted, network adapter (420) communicates with the other components of computer system/server (412) via bus (418). It should be understood that although not shown, other hardware and/or software components could be used in conjunction with computer system/server (412). Examples, include, but are not limited to: microcode, device drivers, redundant processing units, external disk drive arrays, RAID systems, tape drives, and data archival storage systems, etc.

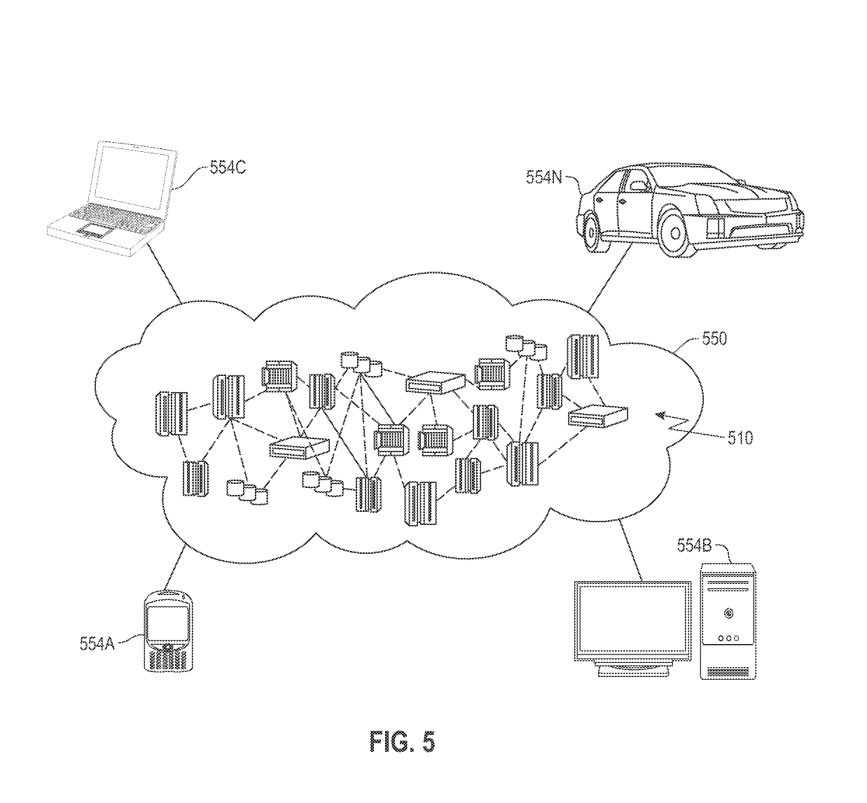

Referring now to FIG. 5, illustrative cloud computing environment (550) is depicted. As shown, cloud computing environment (550) comprises one or more cloud computing nodes (510) with which local computing devices used by cloud consumers, such as, for example, personal digital assistant (PDA) or cellular telephone (554A), desktop computer (554B), laptop computer (554C), and/or automobile computer system (554N) may communicate. Nodes (510) may communicate with one another. They may be grouped (not shown) physically or virtually, in one or more networks, such as Private, Community, Public, or Hybrid clouds as described hereinabove, or a combination thereof. This allows cloud computing environment (550) to offer infrastructure, platforms and/or software as services for which a cloud consumer does not need to maintain resources on a local computing device. It is understood that the types of computing devices (554A)-(554N) shown in FIG. 5 are intended to be illustrative only and that computing nodes (510) and cloud computing environment (550) can communicate with any type of computerized device over any type of network and/or network addressable connection (e.g., using a web browser).

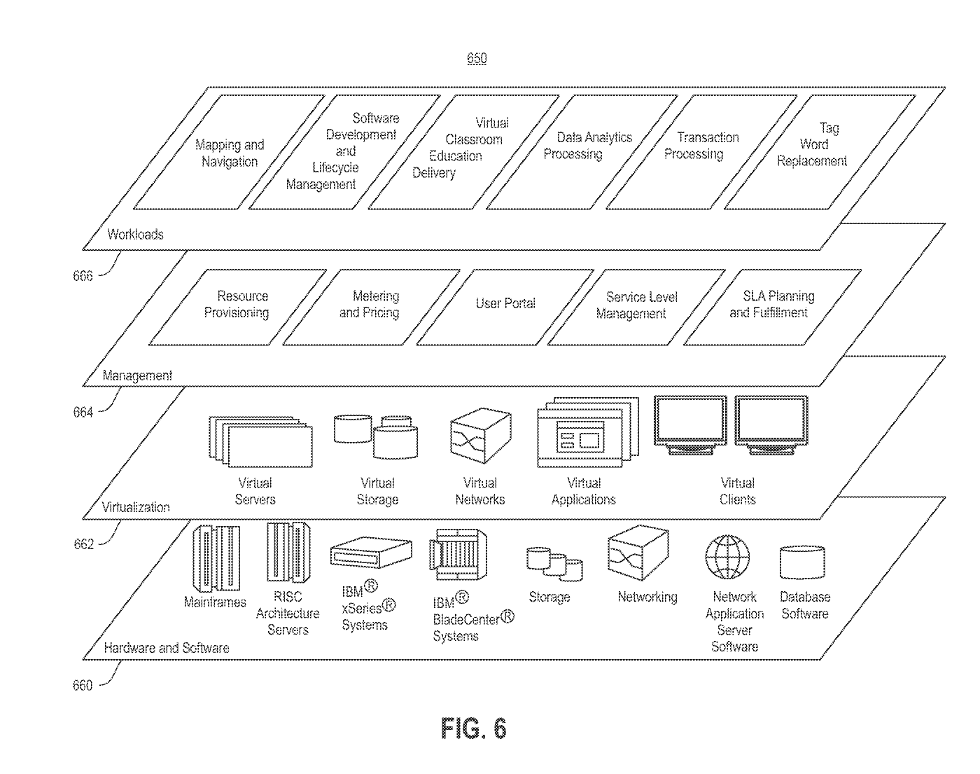

Referring now to FIG. 6, a set of functional abstraction layers provided by cloud computing environment (650) is shown. It should be understood in advance that the components, layers, and functions shown in FIG. 6 are intended to be illustrative only and embodiments of the invention are not limited thereto. As depicted, the following layers and corresponding functions are provided: hardware and software layer (660), virtualization layer (662), management layer (664), and workload layer (666). The hardware and software layer (660) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (662) provides an abstraction layer from which the following examples of virtual entities may be provided: virtual servers; virtual storage; virtual networks, including virtual private networks; virtual applications and operating systems; and virtual clients.

In one example, management layer (664) may provide the following functions: resource provisioning, metering and pricing, and user portal. The functions are described below. Resource provisioning provides dynamic procurement of computing resources and other resources that are utilized to perform jobs within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and jobs, as well as protection for data and other resources. User portal provides access to the cloud computing environment for consumers and system administrators.

Workloads layer (666) provides examples of functionality for which the cloud computing environment may be utilized. Examples of workloads and functions which may be provided from this layer include, but is not limited to: mapping and navigation, software development and lifecycle management, virtual classroom education delivery, data analytics processing, job processing, and data clustering and replacement of tag words separately attached to a data item with a compound word within the cloud computing environment. Data clustering provides cloud computing resource allocation and management such that tag words separately attached to a data items may be replaced.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to data item identification, including, but not limited to, supporting assessment of tag words associated with data items, and replacement of broken tag words with a compound word computationally assessed to replace the broken words.

### Alternative Embodiment

It will be appreciated that, although specific embodiments of the invention have been described herein for purposes of illustration, various modifications may be made without departing from the spirit and scope of the invention. In particular, the system can be applied to identify tag words that are not related to a data item unless it is compounded with a tag word attached to the same data item as the identified tag word. Accordingly, the scope of protection of this invention is limited only by the following claims and their equivalents.

1. (canceled)

2. (canceled)

3. (canceled)

4. (canceled)

5. (canceled)

6. A system comprising:
a shared pool of configurable resources, the shared pool including a physical host in communication with a plurality of physical machines, the physical host having a processing unit in communication with a memory module and data storage;
a list of compound words stored in the data storage, each compound word in the list having at least two stem words;
a functional unit local to the memory module and in communication with the processing unit, the functional unit having tools to support identification of a tag word attached to a data item, the tools comprising:
an identification manager to identify a set of one or more secondary words, each secondary word in the set of secondary words semantically related to a compound word in the list;
an examination manager in communication with the identification manager, the examination manager to examine a data item with at least two attached tag words, including identification of one or more compound words from the list, with each of the stem words in an identified compound word are contained in the attach data item tag words;
a computation manager in communication with the examination manager, the computation manager to compute a semantic relationship between one of the compound words in the list and the data item; and
a recovery manager in communication with the computation manager, the recovery manager to recover at least one identified compound word from the list determined by the computation manager to be semantically related to the data item, including replacement of the at least two attached tag words with the recovered compound word.

7. The system of claim 6, further comprising the computation manager to calculate a probability value proportional to a frequency of co-occurrence of a secondary contextual word and a compound word among a plurality of data items.

8. The system of claim 7, wherein the computed semantic relationship between one of the compound words in the list and the data item is based on the frequency with which words in a set of secondary words semantically related to the compound word are among the attached tag words of the data item.

9. The system of claim 6, wherein the at least two attached tag words of the data item are stem words of a broken compound word.

10. The system of claim 6, wherein each compound word in the list comprises at least two stem words separate by a hyphen.

11. A computer program product for use with a data item for recovering a compound word from two attached tag words, the computer program product comprising:
a computer readable non-transitory storage medium having computer readable program code embodied therewith, which when executed causes a computer to:
identify a set of one or more secondary words, each secondary word semantically related to a compound word having at least two stem words in a list of compound words;
examine data items, each data item having at least two attached tag words, including identification of one or more compound words from the list, each of the stem words in the one or more identified compound words being contained in the attached data item tag words;
compute a relationship between one of the compound words in the list and the data item; and
recover at least one compound word from the list determined to be semantically related to the data item, including replacement of the at least two attached tag words with the recovered compound word.

12. The computer program product of claim 11, further comprising calculation of a probability value proportional to a frequency of co-occurrence of a semantically related secondary word and a compound word among a plurality of data items.

13. The computer program product of claim 12, wherein the computed relationship between one of the compound words in the list and the data item is based on the frequency with which words in a set of secondary words semantically related to the compound word area among the attached tag words of the data item.

14. The computer program product of claim 11, wherein the at least two attached tag words of the data item are stem words of a broken compound word.

15. The computer program product of claim 11, wherein each compound word in the list comprises at least two stem words separate by a hyphen.
